(19) United States
(12) Patent Application Publication
(10) Pub. No.: US 2026/0132024 A1
(43) Pub. Date: May 14, 2026

(54) METHOD AND SYSTEM FOR RELEASING HYDROGEN GAS FROM AN AT LEAST PARTIALLY LOADED CARRIER MATERIAL

(71) Applicant: HYDROGENIOUS LOHC TECHNOLOGIES GMBH, Erlangen (DE)

(72) Inventors: Alexander SEIDEL, Erlangen (DE); Alexander WEIß, Möhrendorf (DE); Alexander PFLÜGER, Oberasbach (DE); Alexander DÜRKSEN, Nürnberg (DE); Caspar PAETZ, Erlangen (DE)

(21) Appl. No.: 19/120,015

(22) PCT Filed: Oct. 5, 2023
(86) PCT No.: PCT/EP2023/077572

§ 371 Date: Apr. 10, 2025

(30) Foreign Application Priority Data
Oct. 13, 2022 (DE) 10 2022 210 822.1

(51) Int. Cl. C01B 3/26

(52) U.S. Cl. CPC C01B 3/26; C01B 2203/0277; C01B 2203/142

(57) ABSTRACT

A method for releasing hydrogen gas from at least partially loaded carrier material includes the following method steps: in a first dehydrogenation reactor (2), dehydrogenating the carrier material from an initial degree of hydrogenation to a first degree of hydrogenation by contacting the carrier material with a catalyst material and thereby releasing hydrogen gas, wherein the carrier material leaves the first dehydrogenation reactor (2) with a liquid phase proportion of at least 5%, transferring the carrier material, which has the first degree of hydrogenation, from the first dehydrogenation reactor (2) into a second dehydrogenation reactor (3, 4), dehydrogenating the carrier material in the second dehydrogenation reactor (3, 4) from the first degree of hydrogenation to a second degree of hydrogenation, and removing by-products from the carrier material.

### CROSS REFERENCE TO RELATED APPLICATIONS

This application is a United States National Phase Application of International Application PCT/EP2023/077572, filed Oct. 5, 2023, and claims the benefit of priority under 35 U.S.C. § 119 of German Application 10 2022 210 822.1, filed Oct. 13, 2022, the entire contents of which are incorporated herein by reference.

### TECHNICAL FIELD

The invention relates to a method and system for releasing hydrogen gas from at least partially loaded carrier material.

### BACKGROUND

Carrier materials which can chemically bond and then release hydrogen in catalytic reactions are known. These catalytic reactions are reversible, in particular completely reversible. Such carrier materials are in particular liquid organic hydrogen carriers which are also referred to as LOHC. In the event of a release reaction which is a dehydrogenation reaction, hydrogen is separated from the organic carrier material. This produces by-products which are in particular liquid and have a higher boiling point than the carrier material. These by-products are undesired. The by-products can be deposited on a catalyst material, which is required for the dehydrogenation reaction, and decrease the activity thereof. The overall efficiency of the dehydrogenation method is reduced. In particular, the catalyst activity is reduced by reason of the fact that the by-products adsorb on the catalyst material and compete in particular with active reaction sites with the carrier material itself. In particular, it has been found that the by-products can react further to form polymers and/or coke-like, solid by-products which, on the one hand, occupy the catalytically active material, in particular a precious metal, and/or clog pore structures of a catalyst carrier. It has also been recognized that if the carrier material evaporates during the dehydrogenation reaction, by-products can accumulate on the catalyst material and lead to an additional reduction in the catalyst activity. The reactivation of the catalyst material is troublesome.

### SUMMARY

It is the object of the invention to improve the overall efficiency of the dehydrogenation procedure, in particular during continuous operation.

This object is achieved in accordance with the invention by a method having features according to the invention and by a system having features according to the invention.

The core of the invention is that by-product deposits on the catalyst material are avoided and/or easily removed by means of suitable process control of the dehydrogenation reaction, in particular from the outset. The by-products which are higher-boiling compounds are removed from the carrier material. Permanent deposits which lead to deactivation of the catalyst material are avoided. The dehydrogenation of carrier material is effected in multiple stages. The carrier material is at least partially loaded, in particular predominantly loaded and in particular fully loaded. The degree of loading is described by the so-called degree of hydrogenation. The carrier material to be dehydrogenated has an initial degree of hydrogenation of at least 85%, in particular at least 90%, in particular at least 95%, in particular at least 98%, in particular at least 99% and in particular at least 99.9%.

A significant finding is also that the dehydrogenation reaction is performed in multiple stages, wherein a plurality of dehydrogenation reactors are arranged in series with one another. In addition or alternatively, further dehydrogenation reactors can be connected in parallel. By performing the dehydrogenation reaction in stages over multiple dehydrogenation stages, the reaction conditions in the respective dehydrogenation reactors can be individually adapted such that they are optimized for the respective dehydrogenation stage. In particular, the reaction conditions can be adapted such that the carrier material is present with a sufficient liquid phase proportion in at least one dehydrogenation reactor, in particular in a plurality and in particular in all dehydrogenation reactors.

In a first dehydrogenation reactor, the carrier material is dehydrogenated from the initial degree of hydrogenation to a first degree of hydrogenation. The carrier material is contacted with a catalyst material and as a result hydrogen gas is released. It is essential that the carrier material leaves the first dehydrogenation reactor with a liquid phase proportion of at least 5%. By reason of the dependence of the vapor proportion of the carrier material on the ratio of hydrogen gas to the carrier material proportion in the dehydrogenation reactor, the liquid phase proportion of the carrier material can vary along the dehydrogenation reactor. In particular, the liquid phase proportion of the carrier material can be greater at the inlet of the dehydrogenation reactor than at the outlet of the dehydrogenation reactor, since the carrier material increasingly transitions into the gas phase, in particular as the hydrogen gas release increases, in particular as the hydrogen gas proportion increases as a result of the dehydrogenation reaction. If the carrier material leaves the first dehydrogenation reactor with a minimum liquid phase proportion, it is ensured that a complete liquid phase is reliably guaranteed over the entire length of the first dehydrogenation reactor.

In particular, the liquid phase proportion is at least 25% and in particular at least 50%. Complete evaporation of the carrier material during dehydrogenation is prevented. The fact that the carrier material is guaranteed to have a liquid phase proportion in the first dehydrogenation reactor means that by-products formed during the dehydrogenation reaction are flushed out of the first dehydrogenation reactor, in particular in a continuous manner. By-products flushed out by the liquid phase proportion of the carrier material can be separated from the carrier material in a removal unit. An accumulation of by-products is thereby avoided. Any impairment of the catalyst performance when using carrier material which is contaminated with by-products is likewise avoided.

By-products are in particular aromatic and/or unsaturated molecules which are particularly large. In particular, large molecules are planar, aromatic, Pi-conjugated hydrocarbon compounds with at least 16 carbon atoms and in particular at least 20 carbon atoms in the carbon skeleton. The by-products are in particular multi-condensed ring systems, especially polycyclic aromatic hydrocarbons (PAHs), in particular pyrene or chrysene. Other by-products can be methyl fluorenes or oligomerized hydrocarbon compounds, in particular ring systems with a plurality of aromatic rings, in particular with four or six aromatic rings.

In particular, the by-products are compounds which differ from the carrier material, in particular from the carrier material in the at least partially loaded and/or partially unloaded form.

Undesired deposition of by-products on the catalyst material is reduced and in particular is prevented. A reduction in catalyst performance is prevented. The effectiveness of the catalyst material is improved. The service life of the catalyst material, i.e. the useful life of the catalyst material, is increased.

The liquid phase proportion of the carrier material can be set according to the vapor-liquid equilibrium, which is also referred to as VLE, in which the carrier material is in thermodynamic equilibrium as a liquid and as a vapor and/or gas. In particular, the liquid phase proportion is directly related to the quantity of hydrogen gas released in the respective dehydrogenation reactor. The greater the proportion of hydrogen gas released in the dehydrogenation reactor, the greater the proportion of vaporous carrier material and the smaller the liquid phase proportion of the carrier material accordingly. The equilibrium position depends substantially on the reaction conditions, in particular pressure and temperature, in the respective dehydrogenation reactor. In principle, the higher the pressure and/or the lower the temperature, the greater the liquid phase proportion. A relevant temperature range is between 250° C. and 350° C. A relevant pressure is greater than 0 barg and is up to 8 barg. The proportion of carrier material in the vapor phase is determined in dependence upon these parameters, the quantity of catalyst and the proportion of hydrogen gas which can be released as a result of dehydrogenation.

One finding of the invention is based on the fact that the reaction conditions in the first dehydrogenation reactor are controlled and in particular regulated in such a manner that the liquid phase proportion is guaranteed. In particular, a comparatively small dehydrogenation difference is accepted so as to avoid the complete vaporization of the carrier material in the first dehydrogenation reactor.

The carrier material which is dehydrogenated in the first dehydrogenation reactor is transferred to a second dehydrogenation reactor where it is further dehydrogenated, i.e. from the first degree of hydrogenation to a second degree of hydrogenation. In particular, further dehydrogenation reactors can be present which are arranged in parallel with the second dehydrogenation reactor and/or in series with, in particular upstream of, the second dehydrogenation reactor, and are connected accordingly. In particular, the second dehydrogenation reactor is the last dehydrogenation reactor in the series arrangement of a plurality of dehydrogenation reactors. The reaction conditions, in particular temperature and pressure, in the second dehydrogenation reactor can be identical or different to those in the first dehydrogenation reactor.

The carrier material is perhydro-dibenzyltoluene (H₁₈DBT), perhydro-benzyltoluene (H₁₂BT), dicyclohexane (C₁₂H₂₂) and/or methylcyclohexane (C₇H₁₄) in a form which is at least partially loaded with hydrogen. In addition or alternatively, it is also possible to use a mixture of carrier material in the form of perhydro-diphenylmethane and perhydro-biphenyl in the form which is at least partially loaded with hydrogen.

The catalyst material has a metal, in particular a precious metal, in particular platinum, palladium, nickel, rhodium, rhenium and/or ruthenium, in particular mixtures and/or alloys of these elements. The metal is catalytically active and is referred to as active material. In particular, the active material is arranged on a catalyst carrier and in particular is fastened thereto. In particular, oxidic material, in particular aluminum oxide, silicon oxide, titanium oxide, zirconium oxide, cerium oxide and/or activated carbon, is used as a catalyst carrier. In particular, the catalyst carrier is a porous material. The pores of the catalyst carrier have a diameter of at least 10 nm, in particular at least 20 nm, in particular at least 50 nm and in particular at least 100 nm. The weight proportion of the catalyst material in relation to the catalyst carrier is between 0.1% and 10%.

The catalyst material comprises a multiplicity of catalyst particles, in particular catalyst carrier particles which are present in particular as pellets. The catalyst particles have an average particle size of 0.5 mm to 10 mm, in particular of 1 mm to 8 mm and in particular of 2 mm to 4 mm.

By virtue of the fact that the dehydrogenation method is performed in multiple stages it is possible to optimize the overall method, above all to the extent that the respective dehydrogenation reactors and the catalyst material located therein can be defined in such a way that they meet the specific requirements in each case of the reaction which is to be expected and, in particular, the dehydrogenation difference range which is to be covered.

This is based on the realization that, in a first deviation range in which in particular the initial degree of hydrogenation is at least 95%, in particular at least 98%, in particular at least 99% and in particular up to 100% and the first degree of hydrogenation HG1 is at most 80%, in particular at most 70% and in particular at most 60%, the dehydrogenation reaction is limited in particular by the heat input. An improvement in the reaction conditions can be achieved in particular by virtue of the fact that
a tube diameter of a reaction tube is reduced in order to increase the heat transmission surface per catalyst mass,
a flow rate is increased e.g. by LOHC circuit control, in order to increase tube-side heat transfer, the loading of the catalyst material with active material is reduced in order to increase the efficiency of the active material, in particular the precious metal,
the catalyst bed is diluted with in particular heat-conducting inert material, in order to increase the catalyst utilization and/or reduce the heat requirement per volume element of the dehydrogenation reactor, and
specific catalysts are used, wherein the catalysts have, in particular in the first deviation range, high levels of activity, such as platinum/rhenium catalyst systems.

In the dehydrogenation reactors in which the low deviation ranges are reproduced, the degree of hydrogenation with which the carrier material is fed into the respective dehydrogenation reactor, in particular the first degree of hydrogenation, is at most 70%, in particular at most 50%, in particular at most 40%, in particular at most 30%, in particular at most 25% and in particular at most 20%. The final degree of hydrogenation with which the carrier material leaves the system, in particular the second degree of hydrogenation, is in particular at most 20%, in particular at most 10%, in particular at most 5%, in particular at most 2% and in particular 0%. In this low hydrogenation degree range, the dehydrogenation reaction is particularly kinetically limited and has higher by-product formation rates. In order to improve the reaction conditions, the following measures are possible:
increasing the tube diameter in the dehydrogenation reactor because there is no limiting heat input.
increasing the carrier material residence time in the dehydrogenation reactor by reducing the volume flow, in particular by prior separation of the hydrogen gas.
increasing the power density in the dehydrogenation reactor by increasing the active material concentration, i.e. in particular the precious metal loading on the catalyst material.
reducing the by-product formation rate by using highly selective catalysts, in particular highly selective catalysts such as sulphidized platinum catalysts and/or sulphidized platinum-rhenium catalysts.

A method wherein the dehydrogenating is effected in the first dehydrogenation reactor with a first dehydrogenation difference of at most 50% and/or the first degree of hydrogenation (HG1) is at least 50% makes it easier to guarantee the liquid phase proportion of the carrier material. It has been found that a dehydrogenation difference in the first dehydrogenation reactor must not be too large in order to ensure a sufficiently large minimum liquid phase proportion of the carrier material as a result of the VLE. The dehydrogenation difference is understood to be the difference between the initial degree of hydrogenation and the first degree of hydrogenation, i.e. before and after dehydrogenation in the first dehydrogenation reactor. It has been found that it is advantageous for maintaining the liquid phase if the dehydrogenation reaction in the first dehydrogenation reactor is selectively incomplete, in particular is effected only partially, wherein the first dehydrogenation difference is at most 50%, in particular at most 40%, in particular at most 30% and in particular at most 25%. In addition or alternatively, the first degree of hydrogenation, i.e. after the dehydrogenation reaction, is at least 50%, in particular at least 60%, in particular at least 70% and in particular at least 75%.

Further dehydrogenation, i.e. unloading of the carrier material, in particular until it is completely unloaded, can take place in further dehydrogenation reactors, i.e. in further dehydrogenation stages. The efficiency of the overall method is guaranteed.

A method which further comprises separating the released hydrogen gas from the carrier material in at least one separating apparatus, which is arranged downstream of the first dehydrogenation reactor and/or downstream of the second dehydrogenation reactor, permits reliable and efficient separation of the material flows, in particular of the released hydrogen gas, from the carrier material. A separating apparatus provided for this purpose is arranged in particular in each case downstream of the first and/or second dehydrogenation reactor. The separating apparatus is designed in particular as a removal unit and in particular as a carrier material cleaning apparatus, in particular as an LOHC cleaning apparatus. The removal unit simplifies the removal of by-products from the liquid carrier material. The removal unit is in particular a liquid-liquid separating apparatus.

A method which further comprises flushing the first dehydrogenation reactor and/or the second dehydrogenation reactor, in particular with carrier material as a flushing medium, for flushing out by-product deposits on the catalyst material, permits uncomplicated removal of by-products which have been deposited on the catalyst material. In particular, it has been found that the dehydrogenation reactors can be efficiently flushed with a flushing medium, wherein the carrier material itself serves as the flushing medium. It is particularly advantageous that the carrier material can efficiently detach by-product deposits from the catalyst material. In particular, the first dehydrogenation reactor, the second dehydrogenation reactor and/or further dehydrogenation reactors can be flushed at the same time or in a time-delayed manner.

A method wherein the carrier material leaves the second dehydrogenation reactor with a liquid phase proportion of at least 5%, wherein in particular the removal of the by-products is effected in a removal unit which is arranged in particular downstream of the dehydrogenation reactors, permits similar and in particular identical reaction conditions in the second dehydrogenation reactor as in the first dehydrogenation reactor. By virtue of the fact that in each case a liquid phase proportion of at least 5% is guaranteed in a plurality and in particular in all dehydrogenation reactors, undesired deposition of by-products on the catalyst material can be prevented. The by-products are reliably flushed with the liquid phase out of the respective dehydrogenation reactor and can then be removed. Troublesome reactivation measures for the catalyst material are not required. It is understood that more than two dehydrogenation reactors can be arranged in series. In particular, the carrier material can be present with a liquid phase proportion of at least 5% in a plurality of and in particular in all dehydrogenation reactors.

A removal unit simplifies the removal of the by-products from the liquid carrier material and in particular a corresponding separation of the liquids, namely the by-products from the carrier material. In particular, the removal unit is arranged downstream of the dehydrogenation reactors. In particular, it is feasible that such a removal unit is spatially separated and, in particular, is arranged spatially remote from the dehydrogenation reactors. The dehydrogenation reactors can be arranged at a first, low-energy location. Low-energy means that there is a demand for electrical energy or that electrical energy is available at comparatively high prices. At this first location, electrical energy is to be made available, in particular through the release of hydrogen gas.

In particular, the removal unit is arranged at a second location remote from the first location. In particular, the second location is energy-rich. Energy-rich means that electrical energy is available at a particularly low cost and/or can be generated inexpensively by means of renewable energy sources, e.g. by photovoltaic plants and/or wind turbines.

In particular, there is no direct fluid connection between the dehydrogenation reactor and the removal unit. An indirect fluid connection from the at least one dehydrogenation reactor to the removal unit can be established e.g. by means of transport vehicles, in particular heavy goods transportation vehicles.

A method wherein the dehydrogenation is effected in the second dehydrogenation reactor with a second dehydrogenation difference of at least 30% and/or at a temperature in the range of 300° C. to 350° C. and/or at a pressure of 0.5 barg to 2.0 barg, permits an increase in the overall efficiency of the dehydrogenation method, in particular in multiple stages. In particular, it has been recognized that the second dehydrogenation reactor can be used as a removal unit. In particular, substantially complete dehydrogenation takes place in the second dehydrogenation reactor. A dehydrogenation difference DH which corresponds to the difference between the first degree of hydrogenation and the second degree of hydrogenation is at least 30%, in particular at least 50%, in particular at least 60%, in particular at least 70%, in particular at least 80%, in particular at least 85% and in particular at least 90%. The temperature in the second dehydrogenation reactor is in the range from 300° C. to 350° C. and in particular from 300° C. to 320° C. A pressure in the second dehydrogenation reactor is in a range between 0.5 barg and 8.0 barg, in particular between 0.5 barg and 2.0 barg.

Under the aforementioned reaction conditions, the carrier material leaves the second dehydrogenation reactor substantially completely and in particular exclusively in gaseous and/or vaporous form. In particular, the carrier material in the second dehydrogenation reactor is not in the liquid phase. The liquid phase proportion is less than 5%, in particular at most 3%, in particular at most 1%, in particular at most 0.1% and in particular 0%.

The second dehydrogenation reactor is the last dehydrogenation reactor, particularly in a series connection of a plurality of dehydrogenation reactors along the flow direction. If further dehydrogenation reactors are present in addition to the first dehydrogenation reactor and the second dehydrogenation reactor, they are arranged in parallel with the second dehydrogenation reactor or upstream in relation to the second dehydrogenation reactor. These further dehydrogenation reactors can be operated in accordance with the first dehydrogenation reactor with a minimum liquid phase proportion of 5% of the carrier material or analogously to the second dehydrogenation reactor such that the carrier material is present substantially completely and in particular exclusively in gaseous and/or vaporous form.

It is particularly advantageous if the second dehydrogenation reactor operated in this manner is the last dehydrogenation reactor. The last dehydrogenation reactor forms a final dehydrogenation stage. In particular, it has been found that such a final dehydrogenation stage can be used as a removal unit. It has been found that, by reason of the high vapor proportion of the carrier material, the removal of by-products from the carrier material is favored by adsorption on the catalyst material. This means that both dehydrogenation of the carrier material and removal of by-products from the carrier material take place in the final dehydrogenation reactor. The last dehydrogenation reactor deactivating in this way can be returned to its original activity by means of suitable regeneration measures, in particular oxidative regeneration.

It is particularly advantageous if a plurality of final dehydrogenation reactors are arranged in parallel with one another and are operated in particular alternately in the regeneration mode and in the dehydrogenation mode. This ensures a continuous and in particular uninterrupted provision of hydrogen gas.

Alternatively or in addition, the removal unit can be arranged directly downstream of a dehydrogenation reactor, in particular the second dehydrogenation reactor. For particularly efficient removal of the by-products from the carrier material by adsorption on the catalyst material, it is advantageous if the dehydrogenation difference in the dehydrogenation reactor used as the removal unit is large and in particular is at least 20%, in particular at least 30%, in particular at least 40% and in particular at least 50%.

A method which further comprises flushing the second dehydrogenation reactor, in particular with carrier material as a flushing medium, in particular during a pause in dehydrogenation, permits the advantageous removal of by-products which have been deposited on the catalyst material. In particular, it has been found that the second dehydrogenation reactor can be efficiently flushed with a flushing medium, wherein the carrier material itself serves as the flushing medium. It has been found that the carrier material is suitable for flushing off by-product deposits from the catalyst material. In particular, no dehydrogenation operation takes place in the second dehydrogenation reactor during the flushing procedure.

A method wherein the reaction conditions are alternated, in particular cyclically, between the first dehydrogenation reactor and the second dehydrogenation reactor, permits dehydrogenation with overall efficiency which is improved on the whole. It has been found that the reaction conditions in the first dehydrogenation reactor and in the second dehydrogenation reactor can be alternated. In particular, the dehydrogenation reactors are operated alternately in liquid-phase mode and in gas-phase mode. The cost for equipment for performing the dehydrogenation method in particular in a continuous manner is reduced. In particular, the reaction conditions in the first dehydrogenation reactor and in the second dehydrogenation reactor can be set cyclically in an alternating manner. In particular, it is feasible to alternate the reaction conditions in the first and second dehydrogenation reactor when a decrease in the catalyst activity in the reactor is established, in particular by a decrease in the hydrogen release rate. In addition or alternatively, alternations in the reaction conditions in the dehydrogenation reactors can also be applied at fixed time intervals, in particular after a fixed operating time.

A method which further comprises regenerating the catalyst material in the second dehydrogenation reactor to remove by-product deposits on the catalyst material, in particular by means of oxidative regeneration, permits additional or alternative removal of the by-products from the catalyst material in the second dehydrogenation reactor. It has been found that the catalyst material can be reactivated in particular by oxidative regeneration. Oxidative regeneration efficiently and reliably removes the by-products from the catalyst material.

A method wherein the oxidative regeneration is effected at a temperature of 250° C. to 600° C., at a pressure which is greater than 0 barg and less than 1 barg, and/or at an oxygen concentration of 0.1 vol. % to 20 vol. %, permits the oxidative regeneration to be performed in an advantageous manner. A temperature which is advantageous for this purpose is between 250° C. and 600° C. and in particular between 300° C. and 500° C. A reaction pressure is in particular between 0 barg and 3 barg, in particular between 0 barg and 1 barg, in particular between 0 barg and 0.5 barg and in particular between 0 barg and 0.1 barg. In addition or alternatively, an oxygen concentration of between 0.1% and 20% by volume is advantageous for oxidative regeneration.

A method wherein two second dehydrogenation reactors are present which are operated, in particular cyclically, in an alternating manner for dehydrogenation and for oxidative regeneration purposes, permits an improvement in the overall efficiency, in particular also with regard to the hydrogen gas release performance, if the catalyst material is oxidatively regenerated in the second dehydrogenation reactor. By virtue of the fact that two second dehydrogenation reactors are present which are operated alternately for dehydrogenation and oxidative regeneration, efficient dehydrogenation on the one hand and reliable reactivation of the catalyst material on the other hand are ensured. It is understood that there can be more than two second dehydrogenation reactors in order to additionally increase the overall efficiency of the method and in particular the flexibility in performing the method.

A system for releasing hydrogen gas from at least partially loaded carrier material (LOHC-H), which system comprises: a first dehydrogenation reactor for dehydrogenating the carrier material from an initial degree of hydrogenation to a first degree of hydrogenation by contacting the carrier material with a catalyst material arranged in the first dehydrogenation reactor, a second dehydrogenation reactor which is located fluidically downstream of the first dehydrogenation reactor, and a removal unit for removing by-products from the carrier material, has essentially the advantages of the method in accordance with the invention, to which reference is hereby made.

A system wherein the removal unit is arranged downstream of the second dehydrogenation reactor, permits independent and reliable removal of the by-products from the liquid carrier material. Separation of, in particular liquid, by-products from the, in particular liquid, carrier material is simple and possible in a separate removal unit. In particular, the removal unit is arranged downstream of the last dehydrogenation reactor. The separation of the, in particular liquid, flows of carrier material and by-products is particularly independent of the dehydrogenation reaction.

A system which further comprises further second dehydrogenation reactor, wherein the removal unit is formed by the second dehydrogenation reactor, in which the catalyst material is regenerated, in particular oxidatively, during alternating operation with the further second dehydrogenation reactor, permits the use of, in particular oxidative, regeneration for the catalyst material, wherein downtimes are avoided by virtue of the alternating operation.

A system which further comprises further dehydrogenation reactors present and arranged in particular in parallel and/or in series with the second dehydrogenation reactor and in particular upstream of the second dehydrogenation reactor, permits increased flexibility in performing the overall method. A plurality of dehydrogenation reactors which in particular can be flexibly interconnected permit in particular the process to be scaled by means of parallel connection and/or additional cascading through a series connection of a plurality of dehydrogenation reactors. The respective reaction conditions in the dehydrogenation reactors connected one behind the other can be adjusted in a more targeted manner to the degrees of hydrogenation of the carrier material which are to be expected.

Both the features stated in the description and the features stated in the exemplified embodiments of a system in accordance with the invention are each suitable, either individually or in combination with one another, for developing the subject matter in accordance with the invention. The respective combinations of features do not constitute any restriction with regard to the developments of the subject matter of the invention, but instead have essentially merely exemplary character.

Further features, advantages and details of the invention will be apparent from the description hereinafter of exemplified embodiments with reference to the drawing. The various features of novelty which characterize the invention are pointed out a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic view of a system in accordance with the invention comprising a plurality of dehydrogenation reactors, in which a carrier material is present in each case with a minimum liquid phase proportion;

FIG. 2 is a view, corresponding to FIG. 1, of a system according to a second exemplified embodiment comprising two dehydrogenation reactors which are operated alternately with different reaction conditions;

FIG. 3 is a view of the functional relationship of the vapor-liquid equilibrium VLE in dependence upon pressure and temperature for different dehydrogenation differences with a minimum liquid proportion of the carrier material benzyl toluene of 10%;

FIG. 4 is a view, corresponding to FIG. 1, of a further exemplified embodiment comprising three dehydrogenation reactors, wherein oxidative regeneration of catalyst material is effected in a dehydrogenation reactor, in particular in alternating operation with a further dehydrogenation reactor.

### DESCRIPTION OF PREFERRED EMBODIMENTS

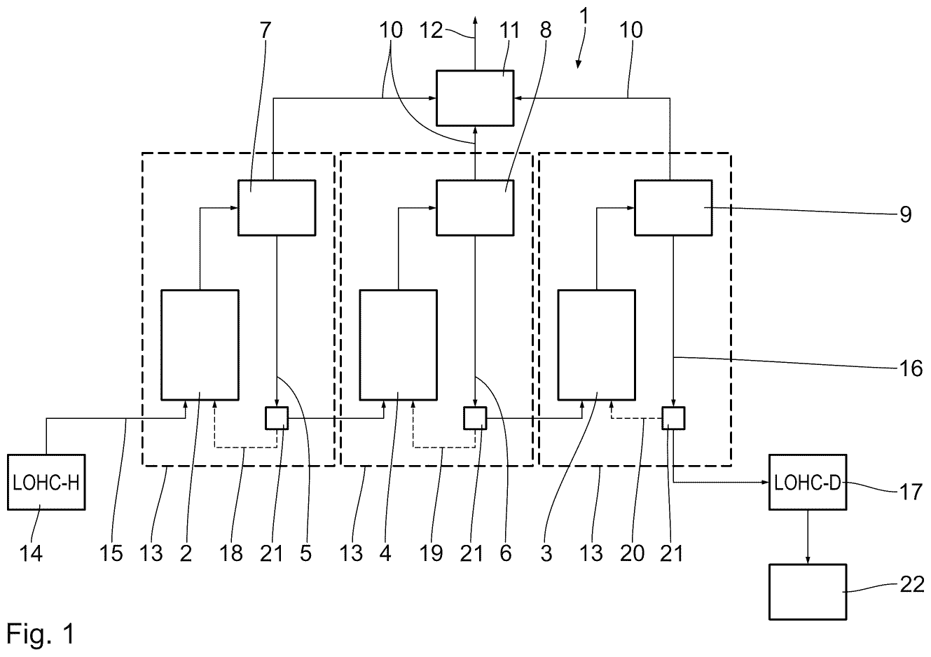

Referring to the drawings, a system designated overall by reference sign 1 in FIG. 1 is used to release hydrogen gas from an at least partially loaded carrier material. In the at least partially loaded state, the carrier material is referred to as LOHC-H. The system 1 comprises a first dehydrogenation reactor 2, a second dehydrogenation reactor 4 arranged in series therewith and an upstream third dehydrogenation reactor 3 arranged in series with the second dehydrogenation reactor 4. The second dehydrogenation reactor 4 is the final dehydrogenation reactor.

The first dehydrogenation reactor 2 and the second dehydrogenation reactor 4 are fluidically connected by means of a first fluid line 5. The second dehydrogenation reactor 4 and the third dehydrogenation reactor 3 are fluidically connected to one another by means of a second fluid line 6. A first separating apparatus 7 is arranged along the first fluid line 5 between the first dehydrogenation reactor 2 and the second dehydrogenation reactor 4. Accordingly, a second separating apparatus 8 is arranged between the second dehydrogenation reactor 4 and the third dehydrogenation reactor 3. A third separating apparatus 9 is arranged downstream of the third dehydrogenation reactor 3. The separating apparatuses 7, 8, 9 are each connected to a hydrogen gas buffer container 11 by means of a hydrogen gas line 10. A hydrogen delivery line 12 is connected to the hydrogen gas buffer container 11 and is used to deliver hydrogen gas to a hydrogen consumer, in particular a fuel cell and/or a hydrogen combustion engine.

A dehydrogenation reactor 2, 3, 4 and the corresponding separating apparatus 7, 8, 9 respectively form a dehydrogenation sub-system 13 of the system 1. The system 1 has a plurality of, in particular three, partial dehydrogenation systems 13, which are connected to one another in a series connection.

The carrier material to be dehydrogenated in the system 1, in particular in the dehydrogenation sub-systems 13, is stored in a first storage container 14 which is connected to the first dehydrogenation reactor 2 via a feed line 15. LOHC-H is stored in the first storage container 14. In principle, it is also feasible that the first storage container 14 is fluidically connected directly to the second dehydrogenation reactor 4 and/or third dehydrogenation reactor 3.

The third separating apparatus 9 is connected to a second storage container 17 via a discharge line 16. At least partially dehydrogenated carrier material LOHC-D is stored in the second storage container 17 in the dehydrogenation sub-systems 13.

A first recirculation line 18 is connected to the first fluid line 5. At least partially dehydrogenated carrier material can be recirculated to the first dehydrogenation reactor 2 via the first recirculation line 18. Accordingly, a second recirculation line 19 is connected to the second fluid line 6 and a third recirculation line 20 is connected to the discharge line 16. In order to direct the fluid flow along the respective fluid line 5, 6, 16, a switchable valve arrangement 21 is arranged in the region of the branch to the recirculation line 18, 19, 20. By means of the valve arrangements 21, a proportion of the fluid flow, which can be determined in a variable manner, in the respective fluid line 5, 6, 16 can be independently recirculated in each case to the respective dehydrogenation reactor 2, 3, 4. The proportion is between 0% and 100%.

A removal unit 22 is arranged downstream of the second storage container 17 and is in fluid communication with the second storage container 17. Undesired by-products can be removed from the liquid carrier material in the removal unit 22.

A method for operating the system 1 is explained in greater detail hereinafter. The at least partially loaded carrier material LOHC-His conveyed from the first storage container 14 via the feed line 15 into the first dehydrogenation reactor 2, where it is contacted with a catalyst material. The fed carrier material LOHC-H has an initial degree of hydrogenation HG0 of at least 90%, in particular at least 95%, in particular at least 98%, in particular at least 99% and in particular at least 99.9%. The dehydrogenation reaction releases hydrogen gas from the carrier material. At least proportions of the carrier material are dehydrogenated. The at least partially dehydrogenated carrier material has a first degree of hydrogenation HG1 which is less than the initial degree of hydrogenation HG0 and which is 70% for the carrier material on leaving the first dehydrogenation reactor 2 according to the exemplified embodiment shown. The first dehydrogenation difference which corresponds to the difference between the initial degree of hydrogenation HG0 and the first degree of hydrogenation HG1 is thus at most 20%, in particular at most 25%, in particular at most 28%, in particular at most 29% and in particular at most 29.9%.

In the first dehydrogenation reactor 2, at least proportions of the carrier material are liquid. A minimum liquid phase proportion of the carrier material is 5%. The minimum liquid phase proportion is ensured in particular by virtue of the fact that a comparatively high pressure, in particular at least 3 barg, in particular at least 4 barg and in particular at least 5 barg, and/or comparatively reduced temperatures of at most 310° C., in particular at most 300° C., in particular at most 290° C. and in particular at most 285° C. are present.

In the first dehydrogenation reactor 2, complete vaporisation of the carrier material is avoided. This can prevent undesired by-products, which can be formed from the carrier material during the dehydrogenation reaction and in particular have a higher boiling point than the carrier material, from becoming deposited on the catalyst material and/or becoming fixedly connected at this location. The undesired by-products are flushed out of the first dehydrogenation reactor 2 together with the liquid carrier material.

The liquids are directed with the released hydrogen gas into the first separating apparatus 7. In the first separating apparatus, the released hydrogen gas is separated from the liquid flow. The hydrogen gas is transported into the hydrogen gas buffer container 11 via the hydrogen gas line 10 and can be intermediately stored therein until it is delivered to a hydrogen consumer via the hydrogen delivery line 12. The liquid flow separated in the first separating apparatus 7 is fed to the second dehydrogenation reactor 4 via the first fluid line 5.

The first separating apparatus 7 can also be used as a removal unit, e.g. in the form of a distillation column. In the first separating apparatus 7, hydrogen gas in particular can be separated from carrier material and/or in particular different qualities of carrier material can be separated from one another and processed separately.

Part of the fluid flow can then be fed to the first dehydrogenation reactor 2 via the first recirculation line 18. The recirculation of at least a partial flow of the carrier material serves in particular to maintain the liquid phase proportion in the first dehydrogenation reactor 2. In particular, an excess of liquid can be provided in a targeted manner in the first dehydrogenation reactor 2, i.e. a mass flow of the carrier material which is greater than the mass flow which reacts with the catalyst material in the first dehydrogenation reactor 2.

In particular, the valve arrangements 21 can be controlled via a central control unit, not illustrated in greater detail. In particular, the valve arrangements 21 can be controlled independently of one another, in particular in a continuously variable manner.

By virtue of the fact that the first dehydrogenation difference in the first dehydrogenation reactor 2 is comparatively small it is easier to maintain the liquid phase of the carrier material.

By virtue of the fact that three dehydrogenation reactors 2, 3, 4 are connected one behind the other in series, it is possible to achieve an overall dehydrogenation difference of at least 70%, in particular at least 80%, in particular 90% and in particular up to 100%. In particular, the overall dehydrogenation difference is distributed substantially uniformly between the three dehydrogenation reactors 2, 3 and 4.

The quantity of hydrogen gas released in the respective dehydrogenation reactors 2, 3, 4 and separated in the respective separating apparatuses 7, 8, 9 is in each case smaller than the total quantity of hydrogen gas delivered via the hydrogen delivery line 12.

The system 1 can have one or more conditioning units for conditioning the hydrogen gas and/or for conditioning the carrier material. Alternatively or in addition, one or more compression stages can be provided in order to compress the released hydrogen gas.

In dependence upon the mode of operation of the system 1, it is also feasible that—at least temporarily—a dehydrogenation sub-system 13 is not operated, i.e. no hydrogen gas is released with the respective dehydrogenation sub-system 13. The system 1 has corresponding bypass lines in order to ensure the fluid flows in a corresponding manner when a dehydrogenation sub-system 13 is not in operation.

In the separating apparatuses 7, 8, 9, in particular at least 50%, in particular at least 75%, in particular at least 90%, in particular at least 95% and in particular at least 99% of the LOHC flow from the respective separating apparatus 7, 8, 9 is then released in liquid phase into the respectively connected fluid line 5, 6, 16.

The separating apparatus 7, 8, 9 is designed in particular as a membrane separating unit, in particular with a palladium membrane. In addition or alternatively, the separating apparatus 7, 8, 9 can have a condenser and/or a scrubber. In addition or alternatively, the separating apparatus 7, 8, 9 can be designed as a reactor with a separating function according to DE 10 2021 200 978 A1 and/or as a compression container according to DE 10 2021 201 368 A1.

Surprisingly, it has been found that a particularly continuous liquid phase flow through the respective dehydrogenation reactor 2, 3, 4 for flushing out the by-products with the higher boiling point can be achieved by virtue of the fact that the ratio of the material quantity of the vaporous carrier material to the gaseous carrier material is less than 1. The following is applicable:

$$1 > = \frac{{n}_{L OHC , vapor}}{{n}_{LOHC , overall}} = \frac{( {p}_{L OHC , vapor} ( T ) \cdot {n}_{{H}_{2}} )}{( {p}_{o v e r a l l} - {p}_{L OHC , vapor} ( T ) ) \cdot {n}_{L OHC , overall}} \qquad ( 1 )$$

It is directly apparent from equation (1) that the liquid phase proportion of the carrier material depends on the quantity of hydrogen gas released and, in particular, is smaller the greater the proportion of hydrogen gas released. Therefore, it is advantageous for the first dehydrogenation reactor to have the smallest possible dehydrogenation difference.

Accordingly, it is possible to indicate the ratio of vaporized carrier material to the overall flow of LOHC material within a dehydrogenation sub-system 13. It is also apparent that maintaining the liquid phase flow tends to be achieved by reducing the quantity of the released hydrogen H₂,
by reducing the dehydrogenation difference,
by increasing the overall system pressure pₒᵥₑᵣₐₗₗ,
by lowering the temperature-dependent LOHC vapor pressure (P_{LOHC, vapor}) by lowering the temperature, and
by increasing the LOHC flow (n_{LOHC, overall}) by increasing the recirculation rate into the respective dehydrogenation reactor 2, 3, 4.

Surprisingly, it has been found that the transition of the reaction from the gas-phase mode to the liquid-phase mode by a combination of all the measures mentioned causes an increase in the reaction rate and as a result in particular the specific requirement of the catalyst material decreases. In particular, it has been found that on average a higher reaction rate can be achieved within the liquid phase.

The carrier material LOHC-D which is fed to the second storage container 17 and is at least partially unloaded has undesired by-products which can be removed from the liquid flow in the removal unit 22. The removal in the removal unit 22 is effected e.g. by thermal methods, in particular rectification and/or distillation, by membrane separation methods and/or by absorptive methods.

The removal step, i.e. the feeding of the unloaded carrier material LOHC-D into the removal unit 22, can be effected cyclically, i.e. each time before the unloaded carrier material LOHC-D is hydrogenated to form LOHC-H in a hydrogenation reactor, not illustrated. For reasons of efficiency, the removal step can be left out in a targeted manner and in particular can be performed only if the concentration of by-products in the carrier material reaches a specific threshold value. Suitable measurements can be performed in order to determine the concentration of by-products in the carrier material. Such measurements are described e.g. WO 2006/127439 A1.

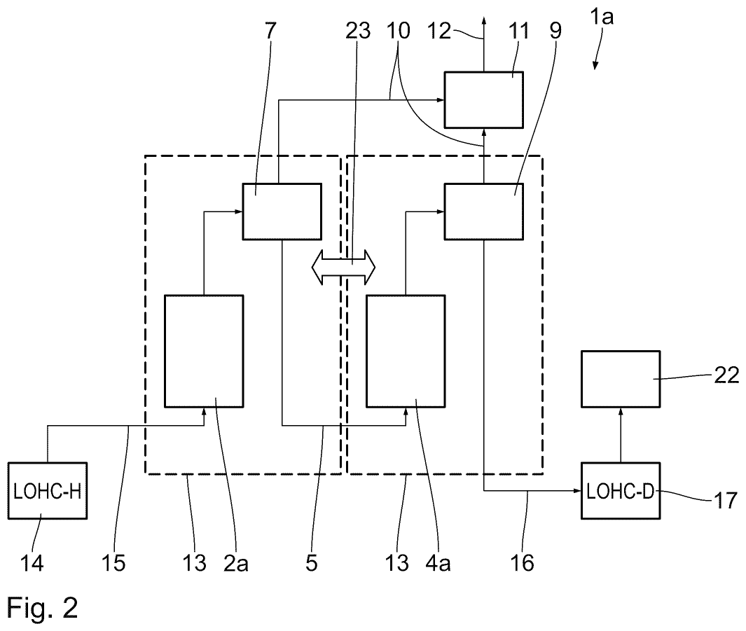

A second exemplified embodiment will be described hereinafter with reference to FIG. 2. Structurally identical parts are designated by the same reference signs as in the previous exemplified embodiment, the description of which is hereby referred to. Structurally different but functionally similar parts are designated by the same reference signs suffixed by the letter a.

The system 1a differs from the previous system in that only two dehydrogenation reactors 2a, 4a are present. The second dehydrogenation reactor 4a forms the final dehydrogenation reactor. In the second dehydrogenation reactor 4a, the reaction conditions are selected in such a way that even low final degrees of hydrogenation between 0% and 20% can be effectively achieved. In particular, the reaction conditions in the second dehydrogenation reactor 4a are such that the temperature is in the range between 300° C. and 340° C., in particular between 300° C. and 330° C. and in particular between 300° C. and 320° C., and the pressure is between 0.5 barg and 5 barg, in particular between 0.5 barg and 3 barg and in particular between 0.5 barg and 2.0 barg.

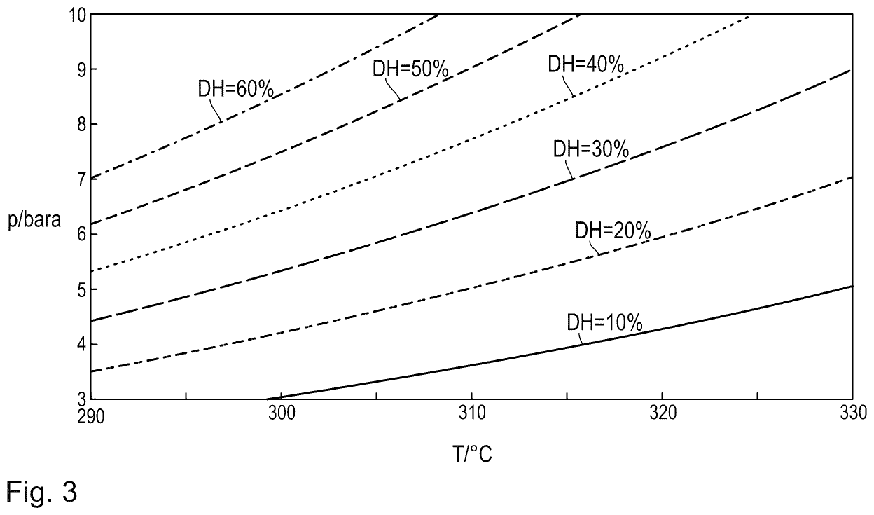

The corresponding dependence of the gas-liquid equilibrium VLE is illustrated in FIG. 3 for dehydrogenation such that the carrier material leaves the dehydrogenation reactor with a minimum liquid content of 10%. It can be deduced quite fundamentally from this that maintaining the liquid phase of the carrier material at higher dehydrogenation differences DH can be ensured by virtue of the fact that the pressure p is increased and/or the temperature T is decreased.

As a result of the reaction conditions selected for the second dehydrogenation reactor 4a, the carrier material in the second dehydrogenation reactor 4a is substantially and in particular completely vaporized. The liquid phase proportion of the carrier material in the second dehydrogenation reactor 4a is less than 5% and is in particular at most 3%, in particular at most 2%, in particular at most 1%, in particular at most 0.1% and in particular at most 0.01%.

It is particularly advantageous that the operation of the dehydrogenation reactors 2a and 4a can be set in a variable manner and in particular can be set so as to be able to alternate cyclically. This is indicated by the double arrow 23 in FIG. 2. This improves the overall cost-effectiveness of system 1a. The hydrogen delivery flow 12 does not have to be reduced.

If a cyclical alternation takes place between the dehydrogenation sub-systems 13, the dehydrogenation reactor, which has previously been operated such that that the carrier material is present in the vapor phase, can then be operated with the carrier material in the liquid phase. It has been surprisingly found that the catalyst material can be regenerated during regular dehydrogenation operation with the carrier material in the liquid phase. In particular, the by-products which have a deactivating effect are separated from the catalyst material by the liquid phase proportion of the carrier material and are flushed out. Additional, in particular separate, flushing measures can be omitted. The overall capacity utilization and thus the overall efficiency of system 1a have increased.

With the system 1a shown in FIG. 2, it is possible in particular to achieve a total dehydrogenation difference of 90% in a two-stage dehydrogenation method with equally dimensioned dehydrogenation reactors 2a, 4a, wherein a continuous liquid phase of the carrier material is ensured in each case in one of the two reactors 2a, 4a.

It is understood that a plurality of dehydrogenation reactors can be present in the system 1a. Accordingly, it is possible to perform the cyclical alternation for the operating modes of the dehydrogenation reactors on a revolving basis, so that a different dehydrogenation reactor is always operated with the liquid phase portion of the carrier material on a revolving basis. A cyclical alternation takes place in particular at least monthly, in particular at least fortnightly, in particular at least weekly, in particular at least every three days and in particular at least daily. This alternation can be performed in particular also in dependence upon the catalyst activity. The catalyst activity is determined in particular on the basis of the hydrogen gas release rate. Should the hydrogen gas release rate falls below a minimum value, in particular within a specified operating window, i.e. in particular at a specified reaction pressure and/or specified reaction temperature, the alternation of operating modes can be initiated. A minimum value for the catalyst activity is provided in particular when there is a decrease in the catalyst activity of at most 50%, in particular at most 30%, in particular at most 10% and in particular at most 1%.

It is essential that at least one dehydrogenation reactor has the carrier material in the liquid phase and at least one further dehydrogenation reactor has the carrier material in the gas phase or vapor phase.

In order to permit the fluid flows into and out of the dehydrogenation reactors 2a, 4a to be flexible, they are each connected independently of one another to the storage containers 14, 17 and/or the separating apparatuses 7, 8 via corresponding fluid lines. Corresponding valves, not shown in FIG. 2 for illustrative reasons, can be used for this purpose.

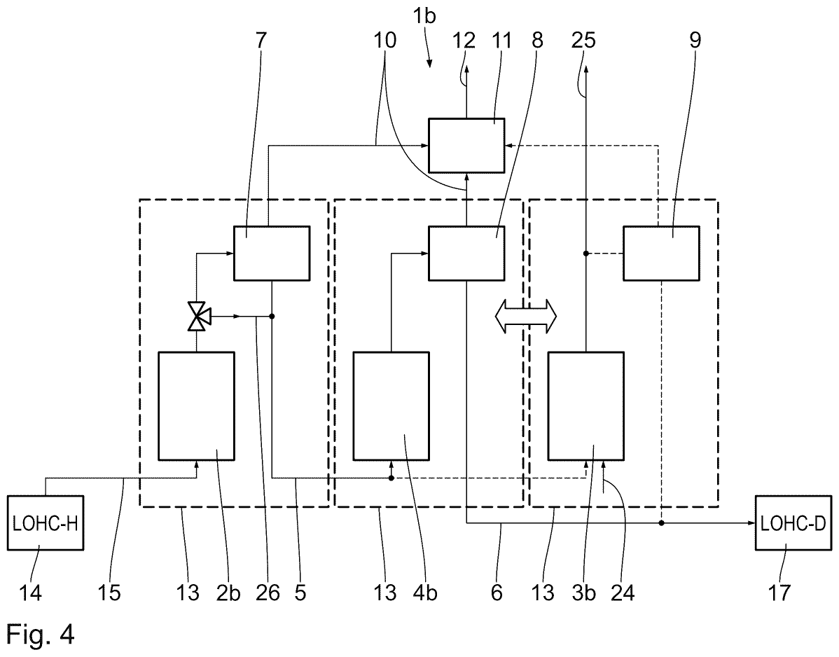

A third exemplified embodiment will be described hereinafter with reference to FIG. 4. Structurally identical parts are designated by the same reference signs as in the previous exemplified embodiments, the description of which is hereby referred to. Structurally different but functionally similar parts are designated by the same reference signs suffixed by the letter b.

The main difference compared to the second exemplified embodiment is that a third dehydrogenation reactor 3b is also present in the system 1b and is operated in cyclical alternation with the second dehydrogenation reactor 4b. A regenerative measure, in particular oxidative regeneration, takes place in the second dehydrogenation reactor 4b. Other regenerative procedures and/or replacement of the catalyst material are also possible. The second dehydrogenation reactor 4b is a final dehydrogenation reactor.

It has been found that the by-product deposits on the catalyst material can be burnt off in an advantageous manner by means of oxidative regeneration, in that an oxygen-containing gas stream is fed via an oxygen supply line 24 and a carbon dioxide-containing exhaust gas is discharged via an exhaust gas line 25. It has thus been recognized that the by-products which have a higher boiling point and are deposited on the catalyst material do not have to be flushed out, but instead the catalyst material itself can be regenerated by means of oxidation. Temperatures between 250° C. and 600° C. and a pressure between 0 barg and 1 barg as well as an oxygen concentration between 0.1 vol. % and 20 vol. % are advantageous for performing the oxidative regeneration.

By virtue of the fact that the oxidative regeneration method is used only for a part of the system 1b, in particular for a dehydrogenation sub-system, the energy expenditure is reduced and in particular is limited only to a part of the overall catalyst inventory. Hydrogen availability is also improved. The reliability of the hydrogen gas supply is increased. In particular, a failure of a dehydrogenation reactor can be compensated for.

In order to minimize downtimes, it is advantageous if the dehydrogenation reactors 3b and 4b are operated in cyclical alternation, wherein one dehydrogenation reactor 3b is operated under dehydrogenating, LOHC-purifying conditions and the other dehydrogenation reactor 4b is operated under oxidatively regenerating conditions. It is also feasible that the dehydrogenation reactors 3b, 4b are operated, at least temporarily, at the same time for dehydrogenation in order to increase in particular the absolute dehydrogenation performance. This permits uncomplicated scaling of the dehydrogenation process.

The respective dehydrogenation reactors 3b and 4b have similar dimensions. The first dehydrogenation reactor 2b can be dimensioned independently thereof.

In particular, it has been recognized that it is possible to accelerate LOHC vaporization in the dehydrogenation reactor 3b if the first separating apparatus 7 is operated deliberately in an inefficient manner. In particular, the vaporization can be additionally accelerated if the fluid flow from the first dehydrogenation reactor 2b is guided past the first separating apparatus 7 via the bypass line 26.

Both reactors 3b, 4b are connected to the first fluid line 5 in order to permit the carrier material to be selectively fed into the second dehydrogenation reactor 4b or third dehydrogenation reactor 3b.

Since, in the system 1b, the by-products are removed by means of oxidative regeneration, a downstream removal unit 22 is not required. The second dehydrogenation reactor 4b forms the removal unit which has an integrated design.

While specific embodiments of the invention have been shown and described in detail to illustrate the application of the principles of the invention, it will be understood that the invention may be embodied otherwise without departing from such principles.

1. A method for releasing hydrogen gas from at least partially loaded carrier material, the method comprising the following method steps:
in a first dehydrogenation reactor, dehydrogenating the carrier material from an initial degree of hydrogenation to a first degree of hydrogenation by contacting the carrier material with a catalyst material and thereby releasing hydrogen gas, wherein the carrier material leaves the first dehydrogenation reactor with a liquid phase proportion of at least 5%;
transferring the carrier material, which has the first degree of hydrogenation, from the first dehydrogenation reactor into a second dehydrogenation reactor;
dehydrogenating the carrier material in the second dehydrogenation reactor from the first degree of hydrogenation to a second degree of hydrogenation; and,
removing by-products from the carrier material.

2. The method as claimed in claim 1, wherein the dehydrogenating is effected in the first dehydrogenation reactor with a first dehydrogenation difference of at most 50% and/or the first degree of hydrogenation is at least 50%.

3. The method as claimed in claim 1, further comprising separating the released hydrogen gas from the carrier material in at least one separating apparatus which is arranged downstream of the first dehydrogenation reactor and/or downstream of the second dehydrogenation reactor.

4. The method as claimed in claim 1, comprising flushing the first dehydrogenation reactor and/or the second dehydrogenation reactor.

5. The method as claimed in claim 1, wherein the carrier material leaves the second dehydrogenation reactor with a liquid phase proportion of at least 5%.

6. The method as claimed in claim 1, wherein the dehydrogenation is effected in the second dehydrogenation reactor with a second dehydrogenation difference of at least 30% and/or at a temperature in the range of 300° C. to 350° C. and/or at a pressure of 0.5 barg to 2.0 barg.

7. The method as claimed in claim 6, further comprising flushing the second dehydrogenation reactor.

8. The method as claim in claim 6, wherein the reaction conditions are alternated between the first dehydrogenation reactor and the second dehydrogenation reactor.

9. The method as claimed in claim 6, further comprising regenerating the catalyst material in the second dehydrogenation reactor to remove by-product deposits on the catalyst material, by means of oxidative regeneration.

10. The method as claimed in claim 9, wherein the oxidative regeneration is effected at a temperature of 250° C. to 600° C., at a pressure which is greater than 0 barg and less than 1 barg, and/or at an oxygen concentration of 0.1 vol. % to 20 vol. %.

11. The method as claimed in claim 9, wherein two second dehydrogenation reactors are present which are operated cyclically, in an alternating manner for dehydrogenation and for oxidative regeneration purposes.

12. A system for releasing hydrogen gas from at least partially loaded carrier material (LOHC-H), the system comprising:
a first dehydrogenation reactor for dehydrogenating the carrier material from an initial degree of hydrogenation to a first degree of hydrogenation by contacting the carrier material with a catalyst material arranged in the first dehydrogenation reactor,
a second dehydrogenation reactor which is located fluidically downstream of the first dehydrogenation reactor, and
a removal unit for removing by-products from the carrier material.

13. The system as claimed in claim 12, wherein the removal unit is arranged downstream of the second dehydrogenation reactor.

14. The system as claimed in claim 12, further comprising further second dehydrogenation reactor, wherein the removal unit is formed by the second dehydrogenation reactor, in which the catalyst material is regenerated during alternating operation with the further second dehydrogenation reactor.

15. The system as claimed in claim 12, further comprising further dehydrogenation reactors present and arranged in parallel and/or in series with the second dehydrogenation reactor.

16. The method as claimed in claim 4, wherein the flushing is effected with carrier material as a flushing medium, for flushing out by-product deposits on the catalyst material.

17. The method as claimed in claim 5, wherein the removal of the by-products is effected in a removal unit which is arranged downstream of the dehydrogenation reactors.

18. The method as claimed in claim 7, the flushing the second dehydrogenation reactor is implemented with carrier material as a flushing medium, during a pause in dehydrogenation.

19. The system as claimed in claim 14, wherein the catalyst material is regenerated oxidatively.

20. The system as claimed in claim 15, wherein the further dehydrogenation reactors are present and are arranged upstream of the second dehydrogenation reactor.
